(19) United States
(12) Patent Application Publication
(10) Pub. No.: US 2006/0028600 A1
(43) Pub. Date: Feb. 9, 2006

(54) High transmittance brightness enhancement optically element for LCD by wholly coating process

(75) Inventors: Yu-Hsun Wu, Hsinchu (TW); Pao-Ju Hsieh, Hsinchu (TW); Hui-Lung Kuo, Hsinchu (TW)

Correspondence Address: BACON & THOMAS, PLLC, 625 SLATERS LANE, FOURTH FLOOR, ALEXANDRIA, VA, 22314, US

(73) Assignee: Industrial Technology Research Institute, Hsinchu (TW)

(21) Appl. No.: 10/909,318

(22) Filed: Aug. 3, 2004

(51) Int. Cl. G02F 1/1335

(52) U.S. Cl. 349/115

(57) ABSTRACT

The present invention discloses a high transmittance brightness enhancement element including a cholesteric liquid crystal film, a quarter-wave film, and preferably a polarizing film formed on a substrate. The cholesteric liquid crystal film and quarter-wave film are formed by coating, and the polarizing film may be formed by coating or adhering a pre-formed polarizing film to the quarter-wave film. The high transmittance brightness enhancement element with polarizing film can be integrated with backlight module to provide a brightness enhancement polarized light source for LCD.

### BACKGROUND OF INVENTION

1. Field of the Invention

The present invention generally relates to a highly brightness enhancing optical element for a backlight type LCD, and more particularly, to a highly brightness enhancing optical element integrated with a polarizing film for a LCD with backlight sub-system supporting.

2. Description of the Prior Art

In all kinds of flat-panel displays, liquid crystal display (LCD) is the only one that employs linearly polarized light to produce brightness, darkness, and grey scale. A linearly polarized light is generated by passing light from backlight module through a polarizer. The linearly polarized light is then shooting into liquid crystal cell to produce brightness and darkness according to the arrangement of liquid crystal molecules in the cell.

However, the final output of the light is only 4-6% of that provided by backlight source. One of the major losses is from the dichroic polarizers of LCD that absorbs half of incident light. Therefore, if the incident light can be transformed to a linearly polarized light that is able to totally transmit the polarizer, the efficiency of the backlight system can be significantly improved and the brightness of the current LCD can thus be enhanced.

A reflective type polarizer has been developed as a brightness enhancement optical element for LCD, which does not absorb light itself. One of the reflective type polarizer is a cholesteric liquid crystal reflective type polarizer, which can turn an unpolarized white light into a circularly polarized lights, left circularly polarized light and right circularly polarized light. One of the circularly polarized lights will transmit the cholesteric liquid crystal film, while the other will be reflected. The circularly polarized light originally reflected by the cholesteric liquid crystal film can be easily converted to a transmissible circularly polarized light by using a simple reflective surface. The backlight module of a LCD usually contains such a reflective mechanism. The transmissible circularly polarized light will pass through the cholesteric liquid crystal film. This means all the light from backlight system will, in theoretically, all pass the and thus generates right or left circularly polarized light with double light intensity. The incident unpolarized white light from the backlight module can be converted to a linearly polarized light with double light intensity, if a quarter-wave plate is attached to the cholesteric liquid crystal film. Such a brightness enhancement optical element can be seen in U.S. Pat. No. 5,506,704, the disclosure of which is incorporated herein by reference.

U.S. Pat. No. 5,506,704 discloses a reflective polarizer made by adhering a quarter-wave plate and a polarizing plate to a cholesteric liquid crystal, wherein the quarter-wave plate is formed by solvent casting or extruding and then being precisely extended. To assembly the reflective polarizer, the quarter-wave plate needs to be coated with an optical paste to make sure that the quarter-wave plate is successfully adhered to the cholesteric liquid crystal. To assure integrity of the quarter-wave plate before it is employed, it is covered with a protective film. Accordingly, the protective film needs to be stripped before proceeding with the adhering step, thereby not only wasting additional material and increasing complexity of manufacturing but increasing the number of interfaces between several layers, which results in optical transmission loss. The polarizing plate is generally made by a more complex extension process, which has an upper and a lower TAC film and an optical paste layer. As a result, the polarizing plate has more interfaces and is thicker in comparison with the quarter-wave plate, which increase the cost of manufacturing and cause a reduction in transmittance, and thus adversely affects the performance of the optical element.

U.S. Pat. Nos. 5,601,884 and 5,743,980 disclose a method of preparing a phase delay plate by coating a glass substrate with a birefringent liquid crystal. U.S. Pat. No. 6,262,788 B1 discloses a method of preparing a phase delay plate by coating a liquid crystal on a TAC film. The objectives of the aforesaid US patents are not directed to an optical conversion for segregated lights from the cholesteric liquid crystal film. In regard to the fabrication of a polarizing plate, U.S. Pat. No. 6,049,428 discloses a novel E-type polarizing plate having a transmitting axis parallel to the molecular optical axis, which is different from the conventional O-type polarizing plate having a transmitting axis perpendicular to the molecular optical axis. However the E-type polarizing plate is basically a light absorption type polarizer, and doesn't have mechanisms for converting a light polarized state and recovering light to enhance brightness.

### SUMMARY OF THE INVENTION

A primary objective of the present invention is to provide a high transmittance brightness enhancement element including a cholesteric liquid crystal film, a quarter-wave film, and preferably a polarizing film formed on a substrate in sequence. The cholesteric liquid crystal film and the quarter-wave film are formed by coating, and the polarizing film may be formed by coating or by adhering a pre-formed polarizing film to the quarter-wave film. The high transmittance brightness enhancement element with the polarizing film can be integrated with a backlight module to provide a brightness enhancement polarized light source for LCD.

A high transmittance brightness enhancement optical element for LCD by wholly coating process constructed according to the present invention comprises a cholesteric liquid crystal film on a substrate; and a quarter-wave film on said cholesteric liquid crystal film, wherein the substrate directly contacts the cholesteric liquid crystal film without an adhesive therebetween, and the cholesteric liquid crystal film directly contacts the quarter-wave film without an adhesive therebetween, wherein the cholesteric liquid crystal film circularly polarizes an incident unpolarized light and the quarter-wave film substantially delays the resulting circularly polarized light reflected from the cholesteric liquid crystal film by its quarter-wavelength, thereby converting the incident unpolarized light to a linearly polarized light when the reflected circularly polarized light is reflected into the cholesteric liquid crystal film.

Preferably, the optical element of the present invention further comprises a polarizing film formed on the quarter-wave film. More preferably, the polarizing film directly contacts the quarter-wave film without an adhesive therebetween. Alternatively, the polarizing film is attached to the quarter-wave film with an adhesive.

Preferably, the substrate is a transparent substrate.

Preferably, the cholesteric liquid crystal film has a cholesteric liquid crystal having a molecular helix with an optical axis perpendicular to the cholesteric liquid crystal film, and with molecular arrangement directions of an upper layer and a lower layer thereof being parallel to orientation of the substrate, so that the cholesteric liquid crystal film can circularly polarize the incident unpolarized light, wherein the cholesteric liquid crystal film is formed of a single layer or layers of cholesteric liquid crystal polymer material.

Preferably, the quarter-wave film comprises a liquid crystal compound having a molecular helix with an optical axis parallel to the quarter-wave film. More preferably, the polarizing film comprises a liquid crystal compound having a molecular helix with an optical axis, wherein the optical axes of the molecular helixes of the liquid crystal compounds of the quarter-wave film and the polarizing film differs by 45 degrees.

Preferably, the molecular helix of the cholesteric liquid crystal of the cholesteric liquid crystal film has different pitches varying continuously or discontinuously from a minimum to a maximum or from a maximum to a minimum.

Preferably, the polarizing film is an O-type polarizing film having a transmitting axis perpendicular to the optical axis of the molecular helix of the liquid crystal compound of the polarizing film.

Preferably, the polarizing film is an E-type polarizing film having a transmitting axis parallel to the optical axis of the molecular helix of the liquid crystal. compound of the polarizing film.

Preferably, the polarizing film is an iodine type or a dichroic dye polarizing film.

According to the present invention, a very thin, integrated type optical polarizer is provided, wherein there is no adhering interface and no adhesive paste at each interface of the substrate/layer/layer structure, so that the optical polarizer can reduce absorption and scattering of light when mounted to the backlight of LCD. Further, according to one preferred embodiments of the present invention, a directly coating method is provided to make an integrated type optical polarizer of the present invention, wherein the cholesteric liquid crystal film, the quarter-wave film and the polarizing film are formed by coating on the same coating machine, so that the material and operational costs are minimized. The present invention requires a relatively less amount of coating material and a single substrate, and is devoid of adhering procedures, which have significant benefits in reducing the cost and the manufacturing sources.

### BRIEF DESCRIPTION OF THE DRAWINGS

FIG. 1 shows a light segregating effect of a brightness enhancement element constructed according to a first embodiment of the present invention by placing the element in parallel and perpendicularly to a polarizing plate separately, wherein the abscissa represents wavelength and the vertiucal axis represents transmittance (T %).

FIG. 2 shows a comparison of transmittance (T %) between the brightness enhancement elements constructed according to the first embodiment of the present invention and the prior art, wherein the transmittance of the former is represented by a bold line and the latter is represented by a thinner line.

### DETAILED DESCRIPTION OF THE PREFERRED EMBODIMENTS

The present invention discloses an optical element as a brightness enhancement mechanism for a backlight type LCD by sequentially directly coating a cholesteric liquid crystal film, quarter-wave film and polarizing film on a single substrate.

The coating is performed with an extruding die or a coating caster directly on a single transparent substrate of an optical grade, such as TAC, PET, PS or polyacrylate. The coating sequence of the cholesteric liquid crystal film, quarter-wave plate and polarizing film is unique and vital, and any change to the coating sequence or the absence of one coating will ruin the brightness enhancement mechanism. At the beginning of the coating process the optical axes of the films should be determined in advance, for example, the optical axis in the cholesteric liquid crystal film needs to be perpendicular to its coating surface. In other words, the molecular arrangement directions of an upper layer and a lower layer of the cholesteric liquid crystal film are parallel to orientation of the substrate, and the molecules between the upper layer and the lower layer are in a helix arrangement, so that the cholesteric liquid crystal film can circularly polarize the incident unpolarized light. The cholesteric liquid crystal film may be formed of a single layer or layers of cholesteric liquid crystal polymer material. To achieve brightness enhancement effect in the whole range of the visible light, the cholesteric liquid crystal film of the present invention needs to have different pitches with a continuous or discontinuous variation from a minimum to a maximum or from a maximum to a minimum.

Furthermore, in the quarter-wave film, its optical axis needs to be parallel to its coating surface, i.e. the molecular arrangement direction needs to be parallel to the orientation of the substrate, thereby having function of delaying the incident wave by a quarter wavelength. The quarter-wave film coated on the cholesteric liquid crystal film has a function of converting the circularly polarized light converted by the cholesteric liquid crystal film to linearly polarized light.

The polarizing film of the optical element of the present invention has its optical axis parallel to its coating surface, and has a transmitting axis and an absorbing axis, which are perpendicular each other, thereby converting an unpolarized light to linearly polarized light. When the polarizing film is employed with the quarter-wave film and the cholesteric liquid crystal film, it should be noted that the angle between the optical axis of the polarizing film and that of the quarter-wave film should substantially differ 45 degrees in order to achieve their respective functions. The polarizing film can be an O-type polarizing plate having a transmitting axis perpendicular to the molecular optical axis thereof, or an E-type polarizing plate having a transmitting axis parallel to the molecular optical axis thereof. Although the polarizing film is preferably formed by a coating method, it can also be formed by adhering a preformed polarizing film to the quarter-wave film.

To obtain the above particular optical axes, the film forming materials adopted by the present invention are compounds having a liquid crystal characteristic or a mixture thereof, in particular a polymeriable nematic liquid crystal, except the cholesteric liquid crystal film. The chosen material of the polarizing film can be a dichroic dye with a liquid crystal characteristic or a raw material of the dichroic dye.

### EXAMPLE 1

Polymerizable cholesteric liquid crystal SLM 90032 and SLM 90034 in a ratio of SLM 90032: SLM 90034=70:30 were dissolved in toluene to obtain a 25 wt % solution, to which 1 wt % UV light initiator Irgacure 907® (Ciba Geigy) was then added. The resultant solution was coated on an orientation-treated PET film of a thickness of 50 μm, and then baked at 80° C. for 2 minutes, followed by irradiation of UV light with 100 W/cm² for 20 seconds, thereby forming a cholesteric liquid crystal film with 5 μm thickness.

Polymerizable liquid crystal SLM 90519 was dissolved in toluene to form a 10 wt % solution, to which 1 wt % UV light initiator Irgacure 907® was then added. The resulting solution was coated on the cholesteric liquid crystal film, and then baked at 80° C. for one minute, followed by UV light irradiation with 100 W/cm² for 20 seconds, thereby forming a film with 2 μm thickness as a quarter-wave film of a brightness enhancement element of the present invention.

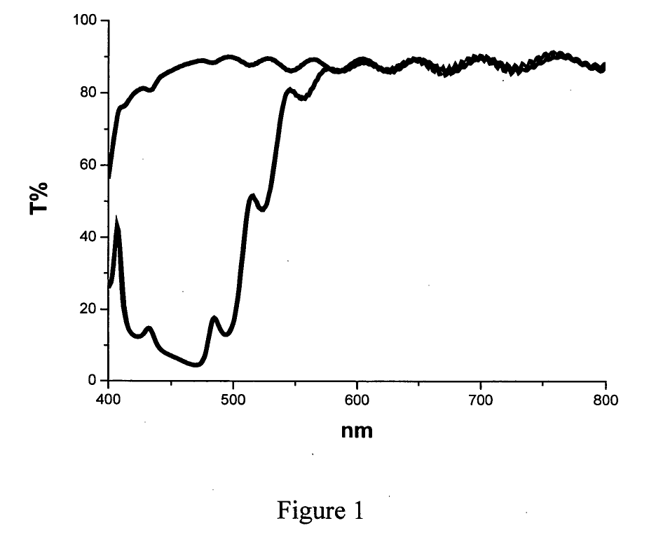

The thickness of brightness enhancement element made by the above method of the present invention is only about 57 μm. FIG. 1 shows spectra of visible light obtained by placing the brightness enhancement element of this example in parallel and perpendicularly to a polarizing plate, separately.

Control Example

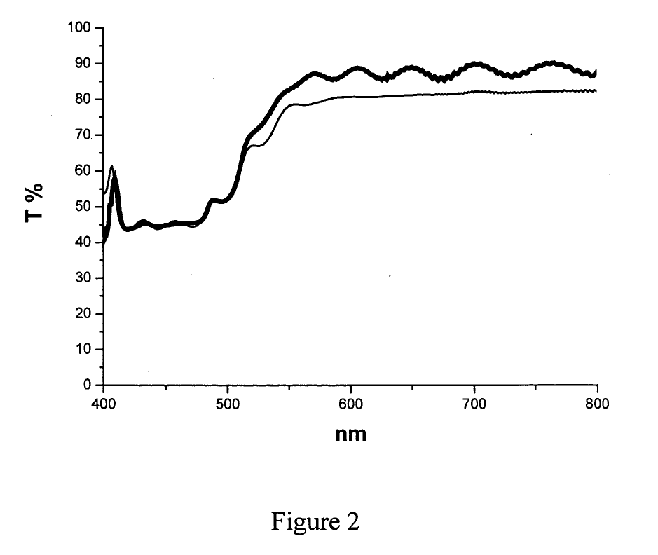

To the cholesteric liquid crystal film formed in Example 1 a commercially available quarter-wave plate having a thickness of 100 μm was adhered to form a brightness enhancement element having a thickness of about 155 μm. FIG. 2 shows a comparison between transmittance spectra of the two brightness enhancement optical elements made in Example 1 and Control Example, wherein the bold line stands for the result of the optical element of the present invention made in Example 1 and the other thinner line stands for the optical element prepared in Control Example. It can be seen from FIG. 2 that the brightness enhancement element of the present invention has a higher transmittance.

### EXAMPLE 2

A brightness enhancement optical element integrated with a polarizing film was prepared in this example by using the brightness enhancement optical element prepared in Example 1. After an optical axis of the quarter-wave film being identified, it was coated with the following solution in a manner such that the angle between the optical axes of the resulting polarizing film and the quarter-wave film was 45 degrees: 20 wt % of a polymerizable liquid crystal SLM 90519, 1 wt % of a UV light initiator Irgacure 907®, and 3 wt % of a black dichroic dye in toluene. The resultant coating was baked at 80° C. for 2 minutes and then irradiated with a UV lamp with 100 W/cm² for one minute, thereby forming a polarizing film as a integral part of a brightness enhancement optical element.

The brightness enhancement optical element made in this example has a thickness of about 59 μm. This optical element having properties of brightness enhancement and higher transmittance can be disposed in a backlight type LCD.

What is claimed is:

1. A high transmittance brightness enhancement optical element for LCD by wholly coating process comprising a cholesteric liquid crystal film on a substrate; and a quarter-wave film on said cholesteric liquid crystal film, wherein the substrate directly contacts the cholesteric liquid crystal film without an adhesive therebetween, and the cholesteric liquid crystal film directly contacts the quarter-wave film without an adhesive therebetween, wherein the cholesteric liquid crystal film circularly polarizes an incident unpolarized light and the quarter-wave film substantially delays the resulting circularly polarized light reflected from the cholesteric liquid crystal film by its quarter-wavelength, thereby converting the incident unpolarized light to a linearly polarized light when the reflected circularly polarized light is reflected into the cholesteric liquid crystal film.

2. The optical element according to claim 1 further comprising a polarizing film formed on the quarter-wave film.

3. The optical element according to claim 2, wherein the polarizing film directly contacts the quarter-wave film without an adhesive therebetween.

4. The optical element according to claim 2, wherein the polarizing film is attached to the quarter-wave film with an adhesive.

5. The optical element according to claim 1, wherein the substrate is a transparent substrate.

6. The optical element according to claim 1, wherein the cholesteric liquid crystal film has a cholesteric liquid crystal having a molecular helix with an optical axis perpendicular to the cholesteric liquid crystal film, and with molecular arrangement directions of an upper layer and a lower layer thereof being parallel to orientation of the substrate, so that the cholesteric liquid crystal film can circularly polarize the incident unpolarized light, wherein the cholesteric liquid crystal film is formed of a single layer or layers of cholesteric liquid crystal polymer material.

7. The optical element according to claim 1, wherein the quarter-wave film comprises a liquid crystal compound having a molecular helix with an optical axis parallel to the quarter-wave film.

8. The optical element according to claim 7, wherein the polarizing film comprises a liquid crystal compound having a molecular helix with an optical axis, wherein the optical axes of the molecular helixes of the liquid crystal compounds of the quarter-wave film and the polarizing film differs by 45 degrees.

9. The optical element according to claim 6, wherein the molecular helix of the cholesteric liquid crystal of the cholesteric liquid crystal film has different pitches varying continuously or discontinuously from a minimum to a maximum or from a maximum to a minimum.

10. The optical element according to claim 8, wherein the polarizing film is an O-type polarizing film having a transmitting axis perpendicular to the optical axis of the molecular helix of the liquid crystal compound of the polarizing film.

11. The optical element according to claim 8, wherein the polarizing film is an E-type polarizing film having a transmitting axis parallel to the optical axis of the molecular helix of the liquid crystal. compound of the polarizing film.

12. The optical element according to claim 4, wherein the polarizing film is an iodine type or a dichroic dye polarizing film.
